(19) United States
(12) Patent Application Publication
(10) Pub. No.: US 2017/0201918 A1
(43) Pub. Date: Jul. 13, 2017

(54) METHOD FOR REESTABLISHING RRC CONNECTION IN LTE SYSTEM AND ELECTRONIC DEVICE THEREOF

(71) Applicant: Samsung Electronics Co., Ltd, Gyeonggi-do (KR)

(72) Inventor: Hyo-Joon Kim, Gyeonggi-do (KR)

(73) Assignee: Samsung Electronics Co., Ltd., Gyeonggi-do (KR)

(21) Appl. No.: 15/508,911

(22) PCT Filed: Sep. 4, 2014
(86) PCT No.: PCT/KR2014/008298

§ 371 Date: Mar. 3, 2017

(51) Int. Cl. H04W 36/08; H04W 76/06; H04L 5/00; H04W 72/04; H04L 1/18; H04W 76/02; H04W 48/12

(52) U.S. Cl. CPC H04W 36/08; H04W 76/028; H04W 76/066; H04W 48/12; H04W 72/042; H04L 1/1816; H04L 5/0007; H04L 5/0055; H04J 2211/005

(57) ABSTRACT

The present disclosure relates to a method for reestablishing an RRC connection in an LTE system and an electronic device thereof, and the method by which a base station reestablishes an RRC connection comprises the steps of: receiving an RRC connection reestablishment request message from an electronic device; confirming whether a context of the electronic device is present in the base station; if the context of the electronic device is not present, receiving a context of the electronic device from a base station which was in the process of an RRC connection with the electronic device; and reestablishing the RRC connection on the basis of the received context.

### BACKGROUND ART

The present disclosure relates to a communication system, and more particularly, to a method and apparatus for establishing a connection of a terminal in a wireless communication system.

A Long Term Evolution (LTE) system performs communication on the basis of Orthogonal Frequency Division Multiple Access (OFDMA) technology using frequency and time division for a common channel. A typical communication system uses a handover technology for smooth communication of a terminal which moves between cells. Especially, an LTE system divides and uses frequency and time for a common channel. Therefore, the LTE system does not support a soft handover technology in which signals between a plurality of cells are synchronized for communication, but supports a hard handover technology for communication with just one cell.

In the LTE system, a base station (enhanced Node B) may manage service and mobility of a terminal through an RRC connection with the terminal. There is a technology for, when a problem in a radio connection between the base station and the terminal occurs, recovering the RRC connection without interrupting the service, and the technology is referred to as an RRC connection reestablishment.

According to the RRC connection reestablishment technology in the LTE system, since a base station having received an RRC connection request message from a terminal manages a context of the terminal, an RRC connection with the terminal can be maintained on the basis of a context being managed, so as to enable the service to continue. If the terminal transmits an RRC connection request signal to another base station, which is not the base station with which the terminal has already been in communication, an RRC connection reestablishment procedure fails since the another base station does not possess the context information. Then, the RRC connection to the terminal is released and the service for the terminal is interrupted. In other words, when a terminal moves between base stations, the service for the terminal may be interrupted.

Accordingly, it is necessary to provide a method by which, when a terminal moves between base stations in an LTE system, the terminal can receive a continuous service without interruption.

### DETAILED DESCRIPTION OF THE DISCLOSURE

### Technical Problem

Accordingly, an embodiment of the present disclosure provides a method and device for reestablishing an RRC connection of an electronic device in an LTE system.

Another embodiment of the present disclosure provides a method and device for reestablishing an RRC connection with a second base station by an electronic device when the electronic device fails to establish a radio link with a first base station.

Another embodiment of the present disclosure provides a method and device for reestablishing an RRC connection according to whether a second base station possesses a context of an electronic device.

Another embodiment of the present disclosure provides a method and device for receiving a context of an electronic device from a first base station when a second base station does not possess the context of the electronic device.

Another embodiment of the present disclosure provides a method and device for reestablishing an RRC connection by a second base station on the basis of a received context of an electronic device.

According to an embodiment of the present disclosure, a method by which a base station reestablishes an RRC connection includes: receiving an RRC connection reestablishment request message from an electronic device; identifying whether a context of the electronic device is present in the base station; when the context of the electronic device is not present, receiving the context of the electronic device from a base station which has been in the process of an RRC connection with the electronic device; and reestablishing the RRC connection on the basis of the received context.

According to an embodiment of the present disclosure, a base station for reestablishing an RRC connection includes: a communication unit configured to receive an RRC connection reestablishment request message from an electronic device; a storage unit configured to store context information relating to at least one electronic device; and a handover controller configured to identify whether a context of the electronic device which has transmitted the RRC connection reestablishment request message is present in the storage unit, and when the context of the electronic device is not present, receive the context of the electronic device from a base station which has been in the process of an RRC connection with the electronic device, and then reestablish the RRC connection on the basis of the received context.

According to another embodiment of the present disclosure, a method of a source base station for an RRC connection reestablishment of an electronic device includes: receiving a request for transmission of a context of the electronic device from another base station in a state where a handover event for an electronic device which has established an RRC connection with the source base station has not occurred; and transmitting the context for the electronic device to the another base station.

According to another embodiment of the present disclosure, a source base station for an RRC connection reestablishment of an electronic device includes: a handover controller configured to receive a request for transmission of a context of the electronic device from another base station in a state where a handover event for an electronic device which has established an RRC connection with the source base station has not occurred; and a communication unit configured to transmit the context of the electronic device to the another base station.

### BRIEF DESCRIPTION OF THE DRAWINGS

FIG. 1 illustrates a system configuration for reestablishing an RRC connection between a base station and an electronic device in an LTE system according to an embodiment of the present disclosure.

FIG. 2 is a block diagram of a base station for reestablishing an RRC connection in an LTE system according to an embodiment of the present disclosure.

FIG. 3A illustrates a procedure for reestablishing an RRC connection on the basis of a context of an electronic device by a base station according to an embodiment of the present disclosure.

FIG. 3B illustrates means for reestablishing an RRC connection on the basis of a context of an electronic device by a base station according to an embodiment of the present disclosure.

FIG. 4 illustrates a procedure for reestablishing an RRC connection with a second base station by an electronic device when the electronic device fails to establish a radio link with a first base station according to an embodiment of the present disclosure.

FIG. 5 illustrates a procedure for reestablishing an RRC connection according to whether a target base station possesses a context of an electronic device according to an embodiment of the present disclosure.

FIG. 6 illustrates a procedure for performing a handover with a target base station when a source base station receives a radio link failure message according to an embodiment of the present disclosure.

### MODE FOR CARRYING OUT THE DISCLOSURE

Hereinafter, exemplary embodiments of the present disclosure will be described with reference to the accompanying drawings. Further, in the following description of the present disclosure, a detailed description of known functions or configurations incorporated herein will be omitted when it may make the subject matter of the present disclosure rather unclear. Further, terms described later are defined in consideration of functions of the present disclosure, but may vary according to the intention or convention of a user or operator. Therefore, the definitions of the terms should be made based on the contents throughout the specification.

In the following description, it is assumed that an RRC connection between an electronic device and a second base station is reestablished when a radio link between the electronic device and a first base station fails in an LTE system. However, the present disclosure is not limited to the LTE system and can be applied to a case of reestablishing the RRC connection in another wireless communication system.

In the following description, an electronic device may be a portable terminal capable of wireless communication with a base station.

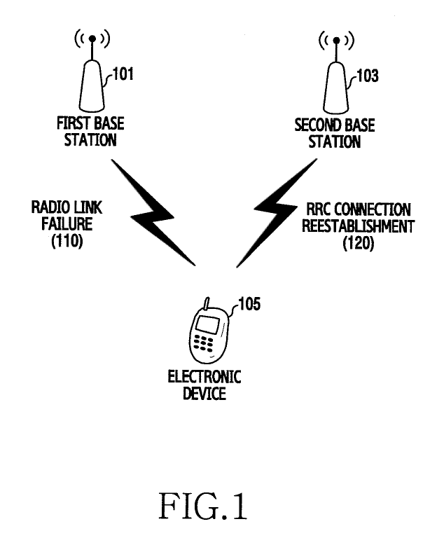

FIG. 1 illustrates a system configuration for reestablishing an RRC connection between a base station and an electronic device in an LTE system according to an embodiment of the present disclosure.

Referring to FIG. 1, an electronic device 105 attempts a Radio Resource Control (RRC) connection reestablishment 120 with a second base station 103 when a radio link with a first base station 101 fails (110). In other words, when the electronic device 105 which has been communicating with the first base station 101 fails in a radio link with the first base station 101 due to a situation such as a movement of the electronic device or the quality deterioration of a radio environment, the electronic device 105 attempts the RRC connection reestablishment 120 with the second base station 103. For example, when the radio link with the first base station 101 fails, the electronic device 105, which is moving toward a serving cell of the second base station 103 while performing wireless communication with the first base station 101, may perform the RRC connection reestablishment 120 with the second base station 103, which is a base station of the serving cell where the electronic device 105 is located. The first base station 101 which has been wirelessly communicating with the electronic device 105 may be referred to as a source base station and the second base station 103 with which the electronic device 105 has attempted the RRC connection reestablishment may be referred to as a target base station.

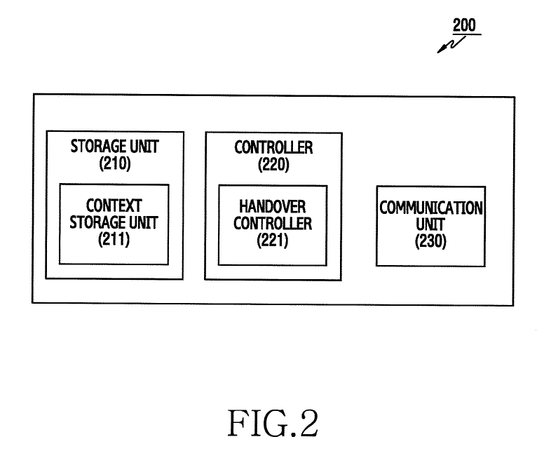

FIG. 2 is a block diagram of a base station for reestablishing an RRC connection in an LTE system according to an embodiment of the present disclosure.

Referring to FIG. 2, a base station 200 may include a storage unit 210, a controller 220, and a communication unit 230.

The storage unit 210 includes a context storage unit 211 and stores data generated while the target base station 200 performs a function.

The context storage unit 211 may store context information relating to an electronic device. Specifically, when the base station 200 and the electronic device are connected through wireless communication, the context storage unit 211 may store connection history information between the base station 200 and the electronic device and may store context information of each of electronic devices, in which the connection history information exists.

In addition, when a context for a handover of the electronic device is received (or acquired) from another base station, the context storage unit 211 may store the context. For example, when a context for a handover of the electronic device is received from a source base station of the electronic device, the context storage unit 211 may store the context.

The controller 220 may include a handover controller 221 and may control a function for performing a general operation of the base station 200 providing a communication service to the electronic device.

The handover controller 221 may control a handover of the electronic device according to whether a context of the electronic device is stored. Specifically, when an RRC connection reestablishment request message is received from an electronic device, the handover controller 221 may determine whether a context of the electronic device is stored in the context storage unit 211, and then control a handover according to whether the context is stored in the context storage unit 211.

First, when the RRC connection reestablishment request message is received from the electronic device, the handover controller 221 determines whether the context of the electronic device is stored in the context storage unit 211.

If the context of the electronic device is stored in the context storage unit 211, the handover controller 221 may reestablish an RRC connection on the basis of the corresponding context.

On the other hand, when the context of the electronic device is not stored in the context storage unit 211, the handover controller 221 may identify information on a source base station of the electronic device from the RRC connection reestablishment request message, and may transmit a message indicating that a radio link between the electronic device and the source base station has failed to the source base station. At this time, the handover controller 221 may additionally transmit a context request message for the electronic device when transmitting a radio link failure message.

Here, the source base station may refer to a base station with which the electronic device had previously established an RRC connection but has failed in a radio link due to a situation such as a movement of the electronic device or the quality deterioration of a radio environment.

Thereafter, the handover controller 211 may receive a handover request message from the source base station, transmit an acknowledge (ACK) for a handover to the source base station in order to notify that the handover request message is received, and then perform the handover with the source base station. When the handover with the source base station is performed, the handover controller 211 may receive a context of the electronic device from the source base station and perform the handover on the basis of the received context.

Thereafter, the handover controller 211 reestablishes the RRC connection with the electronic device, thereby providing a continuous service to the electronic device without service interruption due to the RRC connection release.

In addition, when a message indicating that a radio link between a specific electronic device and a corresponding base station has failed is received from another base station, the handover controller 211 identifies whether context information of the electronic device exists in the context storage unit 211. When the context information of the electronic device exists, the handover controller 211 transmits a handover request message to another base station, receives an ACK message for the handover request message, and then controls and processes a function for transmitting the context information of the electronic device to the another base station.

The communication unit 230 may transmit or receive data to or from the source base station and the electronic device. The communication unit 230 may include a radio frequency receiver and transceiver, and/or an optical (e.g., infrared) receiver and transceiver. For example, the communication unit 230 may include a wireless communication system supporting one of a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wi-Fi network, a WiMax network or/and a Bluetooth network. A wireless communication system according to an embodiment of the present disclosure is not limited to a wireless communication system supporting the networks described above, but may be a wireless communication system supporting other networks. The communication unit 230 according to the present disclosure may receive an RRC connection reestablishment request message from the electronic device.

In addition, the communication unit 230 may transmit a radio link failure message including a context request message to the source base station.

In addition, the communication unit 230 may transmit or receive data for performing a handover to or from the source base station and the electronic device.

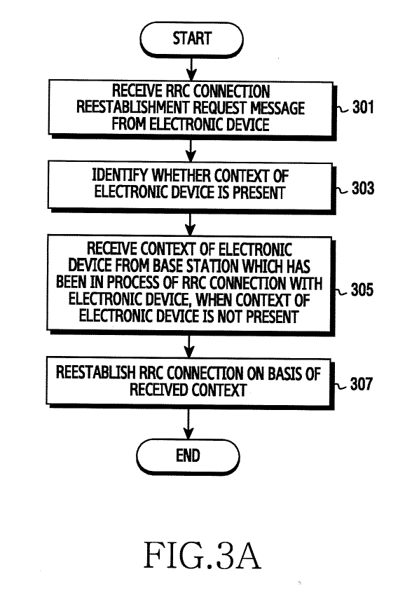

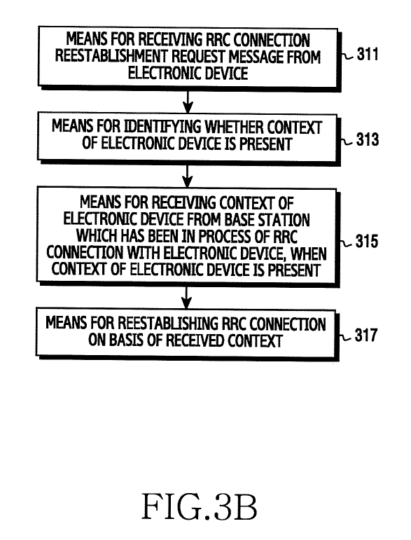

FIG. 3A illustrates a procedure for reestablishing an RRC connection on the basis of a context of an electronic device by a base station according to an embodiment of the present disclosure.

Referring to FIG. 3A, in step 301, a base station may receive (or acquire) a Radio Resource Control (RRC) connection reestablishment request message from an electronic device. The base station may receive the RRC connection reestablishment request message from the electronic device which has failed in a radio link with another base station.

Thereafter, in step 303, the base station identifies whether a context of the electronic device exists. At this time, context information of the electronic device may be stored in a base station in which the history of performing wireless communication with the electronic device exists, and the context information of the electronic device may not be stored in a base station in which the history of performing wireless communication with the electronic device does not exist.

Thereafter, when the context of the electronic device does not exist, the base station may proceed to step 305 and receive the context of the electronic device from a base station which has been previously in the process of a RRC connection with the electronic device. Specifically, when the context of the electronic device does not exist, the base station may transmit a message requesting the context of the electronic device to the base station which has been previously in the process of an RRC connection with the electronic device, and receive the context of the electronic device from the base station which has been in the process of an RRC connection with the electronic device.

Thereafter, the base station may proceed to step 307 and reestablish the RRC connection on the basis of the received context. Accordingly, the electronic device may receive a seamless service without interruption of the service by the RRC connection release.

Thereafter, the base station may terminate a procedure according to an embodiment of the present disclosure.

FIG. 3B illustrates means for reestablishing an RRC connection on the basis of a context of an electronic device by a base station according to an embodiment of the present disclosure.

Referring to FIG. 3B, the base station includes a means 311 for receiving an RRC connection reestablishment request message from the electronic device.

In addition, the base station includes a means 313 for identifying whether a context of an electronic device is present. At this time, the base station may include a means for storing and managing context information relating to the electronic device which had been connected.

In addition, when the context of the electronic device is not present, the base station includes a means 315 for receiving the context of the electronic device from a base station which has been in the process of an RRC connection with the electronic device. At this time, the base station may include a means for transmitting a context request message to the base station which has been in the process of the RRC connection with the electronic device.

In addition, the base station includes a means 317 for reestablishing the RRC connection on the basis of the received context.

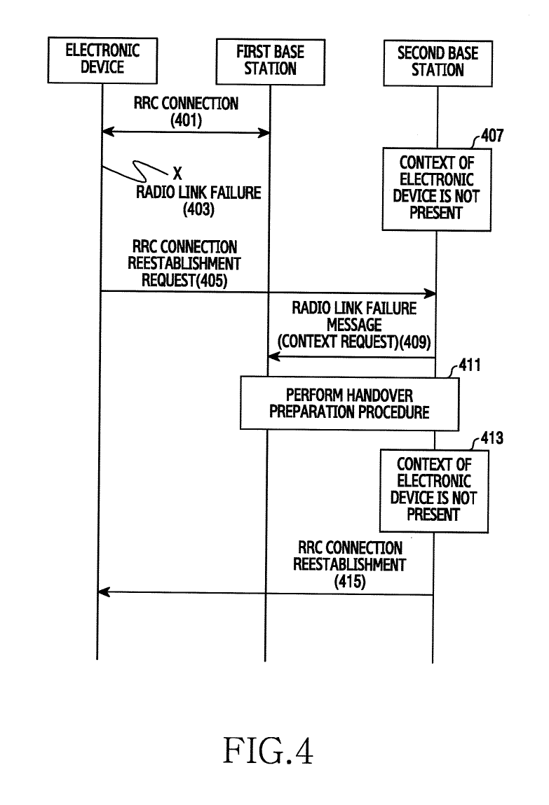

FIG. 4 illustrates a procedure for reestablishing an RRC connection with a second base station by an electronic device when the electronic device fails to establish a radio link with a first base station according to an embodiment of the present disclosure.

In the following description, a first base station refers to a source base station and a second base station refers to a target base station.

Referring to FIG. 4, an electronic device performs and maintains an RRC connection with the first base station (step 401).

Thereafter, when a radio link failure occurs between the electronic device and the first base station (step 403), the electronic device may request an RRC connection reestablishment to the second base station (step 405). At this time, it is assumed that the second base station does not store a context of the electronic device (step 407).

The second base station identifies that the context of the electronic device is not stored and transmits a message indicating that the electronic device has failed in the radio link to the first base station which has established an RRC connection with the electronic device. At this time, the second base station may transmit, to the first base station, a radio link failure message including a context transmission request message for the electronic device (step 409).

Thereafter, the first base station and the second base station may perform a handover preparation procedure for exchanging the context of the electronic device (step 411). The handover preparation procedure is performed in order to prevent a service provided to the electronic device from being interrupted when the electronic device moves.

Since the second base station has received the context of the electronic device from the first base station through the handover preparation procedure, the second base station may store the context of the electronic device after the handover preparation procedure is performed (step 413).

Thereafter, the second base station may reestablish the RRC connection of the electronic device on the basis of the context of the electronic device (step 415).

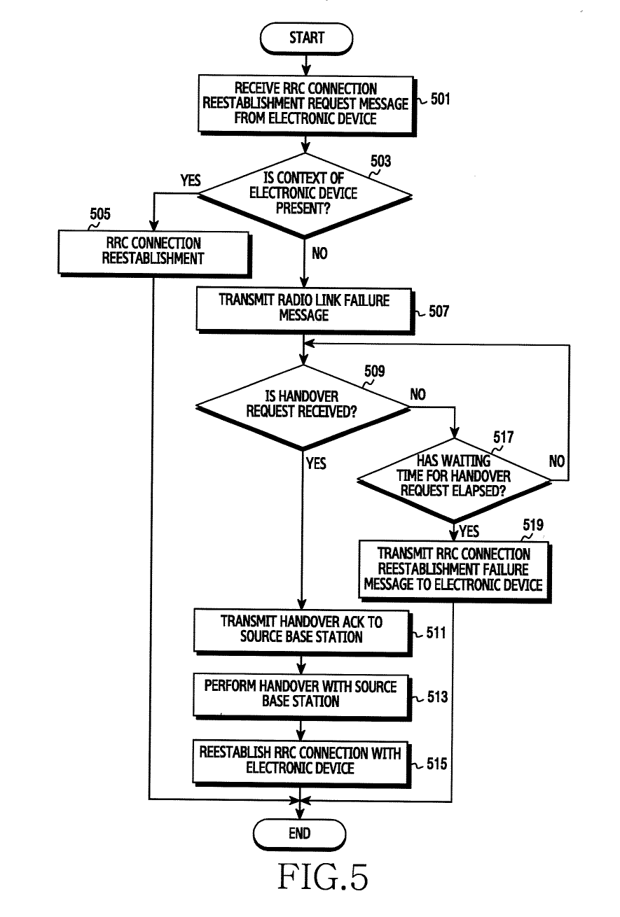

FIG. 5 illustrates a procedure for reestablishing an RRC connection according to whether a target base station possesses a context of an electronic device according to an embodiment of the present disclosure.

Referring to FIG. 5, a target base station may receive an RRC connection reestablishment request message from an electronic device in step 501. At this time, the electronic device assumes that a radio link with a source base station is in a failed state.

Thereafter, in step 503, the target base station identifies whether a context of the electronic device is present.

When the context of the electronic device is present, the target base station reestablishes an RRC connection in step 505. Thereafter, the target base station terminates a procedure according to an embodiment of the present disclosure.

On the other hand, when the context of the electronic device is not present, the target base station proceeds to step 507 and transmits a radio link failure message to the source base station. At this time, the target base station may transmit, to the source base station, a radio link failure message including a context request message for the electronic device.

Thereafter, the target base station identifies whether a handover request is received in step 509. Specifically, the target base station may identify whether a handover request message is received from the source base station.

When the handover request is received, the target base station proceeds to step 511 and transmits a handover ACK to the source base station.

Thereafter, the target base station may perform a handover with the source base station in step 513. At this time, the target base station may receive a context from the source base station and perform the handover on the basis of the received context.

Thereafter, the target base station may reestablish an RRC connection with the electronic device in step 515.

Thereafter, the target base station terminates a procedure according to an embodiment of the present disclosure.

On the other hand, when the handover request is not received, the target base station proceeds to step 517 and identifies whether a waiting time for the handover request has elapsed. In other words, the target base station may identify whether the handover request is received until the entire waiting time for the handover request has elapsed.

When the waiting time for the handover request has elapsed, the target base station transmits an RRC connection reestablishment failure message to the electronic device in step 519. Thereafter, the target base station terminates a procedure according to an embodiment of the present disclosure.

On the other hand, when the waiting time for the handover request has elapsed, the target base station returns to step 509 and re-performs the following steps.

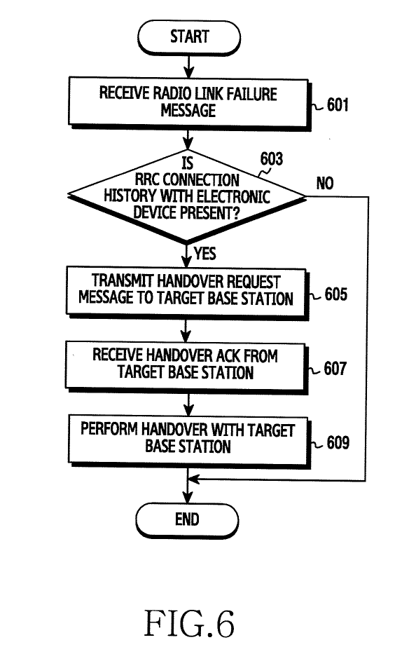

FIG. 6 illustrates a procedure for performing a handover with a target base station when a source base station receives a radio link failure message according to an embodiment of the present disclosure.

Referring to FIG. 6, in step 601, a source base station receives a radio link failure message from a target base station. Specifically, the source base station may receive, from the target base station, a message indicating that the electronic device has failed establishing a radio link with the source base station. At this time, the received radio link failure message includes a context request message for the electronic device.

Thereafter, in step 603, the source base station identifies whether an RRC connection history with the electronic device is present. In other words, the source base station may identify whether an RRC connection history with the electronic device which has failed in the radio link is present or whether a context of the electronic device is present.

When the RRC connection history with the electronic device is present, the source base station proceeds to step 605, transmits a handover request message to the target base station, and receives an ACK for the handover request message from the target base station in step 607.

Thereafter, in step 609, the source base station may perform a handover with the target base station. In the handover preparation procedure, the source base station may transmit the context of the electronic device to the target base station. Thereafter, the source base station terminates a procedure according to an embodiment of the present disclosure.

On the other hand, when the RRC connection history with the electronic device is not present, the source base station terminates a procedure according to an embodiment of the present disclosure.

Embodiments and all functional operations described in the present disclosure may be carried out by computer software, firmware, hardware, or one or more combinations thereof, which include the structures disclosed in the present disclosure and equivalent structures thereof. Further, embodiments of the present disclosure described in the present disclosure may be executed by one or more computer program products, i.e. data processing devices, or carried out by one or more modules of computer program commands encoded in computer-readable media for controlling the operations of the devices.

A computer-readable medium may be a machine-readable storage medium, a machine-readable storage substrate, a memory device, a configuration of a material influencing a machine-readable electric wave stream, or one or more combinations thereof. The term “data processing device” includes, for example, a programmable processor, a computer, or all nodes, devices, and machines, including a multi-processor or computer, for processing data. The node may include, in addition to hardware, a code that creates an execution environment for a computer program, for example, a code that constitutes processor firmware, a protocol stack, a database management system, an operating system, or one or more combinations thereof.

Although specific exemplary embodiments have been described in the detailed description of the present disclosure, various changes and modifications may be made without departing from the spirit and scope of the present disclosure. Therefore, the scope of the present disclosure should not be defined as being limited to the described embodiments, but should be defined by the appended claims and equivalents thereof.

1. A method of a base station for establishing a connection with a terminal, the method comprising:
receiving information regarding a context of the terminal from another base station being connected with the terminal; and
establishing the connection with the terminal based on the context of the terminal.

2. The method of claim 1, further comprising:
receiving, from the terminal, a message for requesting the connection;
identifying the another base station after the receiving of the message from the terminal; and
transmitting, to the another base station, a radio link failure message indicating that a radio link between the terminal and the another base station has failed.

3. The method of claim 2, wherein the transmitting of the radio link failure message to the another base station comprises, if the radio link failure message is transmitted, transmitting a context request message for requesting the context of the terminal to the another base station.

4. The method of claim 2, wherein the information regarding the context of the terminal is received by performing a handover preparation procedure with the another base station after the radio link failure message is transmitted.

5. The method of claim 2, further comprising:
after the radio link failure message is transmitted, determining whether a message for a handover request for the terminal is received from the another base station within a predetermined period of time; and
if the handover request message for the terminal is received from the another base station within the predetermined period of time, transmitting a response message for the handover request to the another base station.

6. The method of claim 5, further comprising:
transmitting a connection failure message to the terminal if the message for the handover request for the terminal is not received from the another base station within the predetermined period of time.

7-9. (canceled)

10. A base station for establishing a connection with a terminal, the base station comprising:
at least one transceiver configured to receive information regarding a context of the terminal from another base station being connected with the terminal; and
at least one processor configured to establish the connection with the terminal based on the context of the terminal.

11. The base station of claim 10, wherein the at least one transceiver is further configured to receive, from the terminal, a message for requesting the connection,
wherein the at least one processor is further configured to identify the another base station after receiving the message from the terminal, and
wherein the at least one transceiver is further configured to transmit, to the another base station, a radio link failure message indicating that a radio link between the terminal and the another base station has failed.

12. (canceled)

13. A base station for supporting a connection establishment of a terminal, the base station comprising:
at least one transceiver configured to:
receive, from another base station, a message for requesting a context of the terminal in a state where a handover event for the terminal being connected with the base station has not occurred; and
transmit information regarding the context of the terminal to the another base station upon receiving the information.

14. The base station of claim 13, wherein the transceiver is further configured to receive a radio link failure message indicating that a radio link between the terminal and the another base station has failed.

15. The base station of claim 13, wherein the transceiver is further configured to:
if the information regarding the context of the terminal is transmitted to the another base station, transmit a message for a handover request for the terminal to the another base station; and
receive a response message for the handover request.

16. The base station of claim 14, wherein the information regarding the context of the terminal is transmitted by performing a handover preparation procedure with the another base station after the radio link failure message is received.

17. The base station of claim 13, wherein a connection between the terminal and the another base station is established based on the context of the terminal.

18. The base station of claim 15, wherein a connection between the terminal and the base station is maintained if the message for the handover request for the terminal is not transmitted within a predetermined period of time.

19. The method of claim 1, further comprising:
identifying whether the context of the terminal is present in the base station,
wherein the receiving of the information regarding the context of the terminal from the another base station being connected with the terminal comprises, if the context of the terminal is not present in the base station, receiving the information regarding the context of the terminal from the another base station.

20. The base station of claim 10, wherein the at least one processor is further configured to identify whether the context of the terminal is present in the base station, and
wherein the at least one transceiver is further configured to, if the context of the terminal is not present in the base station, receive the information regarding the context of the terminal from the another base station.

21. The base station of claim 11, wherein the at least one transceiver is further configured to, if the radio link failure message is transmitted, transmit a context request message for requesting the context of the terminal to the another base station.

22. The base station of claim 11, wherein the information regarding the context of the terminal is received by performing a handover preparation procedure with the another base station after the radio link failure message is transmitted.

23. The base station of claim 11, wherein the at least one processor is further configured to, after the radio link failure message is transmitted, determine whether a message for a handover request for the terminal is received from the another base station within a predetermined period of time, and
wherein the at least one transceiver is further configured to, if the handover request message for the terminal is received from the another base station within the predetermined period of time, transmit a response message for the handover request to the another base station.

24. The base station of claim 23, wherein the at least one transceiver is further configured to transmit a connection failure message to the terminal if the message for the handover request for the terminal is not received from the another base station within the predetermined period of time.
